(19) United States
(12) Patent Application Publication
(10) Pub. No.: US 2014/0069255 A1
(43) Pub. Date: Mar. 13, 2014

(54) PERCUSSION DEVICE

(71) Applicants: Evgeny Y. Kolchinsky, Moscow (RU); Olga B. Salmina, Moscow (RU)

(72) Inventors: Evgeny Y. Kolchinsky, Moscow (RU); Olga B. Salmina, Moscow (RU)

(21) Appl. No.: 14/046,989

(22) Filed: Oct. 6, 2013

(30) Foreign Application Priority Data
Apr. 6, 2012 (RU) PCT/RU2012/000257

(51) Int. Cl. G10D 13/00

(52) U.S. Cl. CPC G10D 13/00
USPC 84/402

(57) ABSTRACT

The claimed device relates to devices for creating sound, to percussion devices in particular, and can be used both as a rhythmic instrument and as the background sound effects for sporting events. The percussion device comprises at least two percussion instruments 1 and the mounting unit 2. The percussion instrument 1 has a stem 4 and percussion surface which interacts with another percussion instrument 1 and/or percussion surface. The mounting point 2 is made of elastic material and has holes 3 for mounting the stems 4 of the percussion instruments 1, wherein the maximum angle between the axes of the holes does not exceed 45°. In this particular case, spoons can be used as percussion instruments.

### FIELD OF THE INVENTION

The claimed device relates to devices for creating sound, to percussion devices in particular, and can be used both as a rhythmic instrument and as the background sound effects for sporting events.

### BACKGROUND OF THE INVENTION

Wooden spoons are known to be used as the rhythmic percussion instruments. There are many techniques for playing the spoons. However, playing the spoons requires special training. For example, with no training, it is possible to hold the spoons incorrectly in the hands. In this case, fingers that hold the spoons can become sore.

The use of percussion devices is known in the prior art. A musical instrument called “Spoons in the mount” and described on the website http://www.masteras.ru/catalog/shum/lozhki/lozh_stan consists of two wooden spoons that are connected together by a vinyl chloride ring with a diameter of 20 mm. The stem ends of the spoon are ground down at an angle of 45 degrees. At the rear ends of the stems a hidden thorn is mounted that allows positioning the spoons strictly against each other. The technique of playing this instrument is in striking spoons on different surfaces, whereas the convex surfaces of the bowls are struck together in different ways and the hit produces a bright clicking sound. The disadvantage of this musical instrument is the relative instability of the mounting which can result in damage of wooden parts of the mounting.

Another technical solution is described on the following website http://www.spacenation.info/lojki.html. According to the description, spoons are mounted together with a bent thin steel strip which serves as a spring. The convex surfaces of the bowls face each other. The playing technique in this case is that the spoons are held in the left hand and the index and middle fingers of the right hand strike the edges of the spoons one at a time.

Patent CN 2470910 Y describes the invention in which a flap plate is used as a percussion device, which comprises a handle, a fixed flap plate fixed on the handle, a pair of protrusion pieces at joint between the handle and the fixed flap plate, and a movable flap plate movably connected on the protrusion pieces. By using a hand to swing the handle hardly, the movable flap plate can repeatedly impact the fixed flap plate to generate sound. The disadvantage of the tool is the inability to obtain a rapid pace.

Patent U.S. 2006225558 describes a device in which two claves were connected together with a hinge type structure into a single device. This mounting structure allows using only one hand during playing, whereas previously both hands had to be engaged. However, this invention relates to claves only and does not show how it can be used with other percussive devices.

U.S. Pat. No. 5,007,322 describes the closest device in technical essence to the one proposed herein. Said device allows keeping multiple percussion instruments with one hand simultaneously. The device consists of two hollow grips that are cut along and interconnected with an elastic curved rod made of soft elastic metal. A frame biases grips away from each other. Grips can be disassembled to attach percussion mallets and then are connected with screws. The proposed device is mainly intended for attaching percussion mallets to play the percussion devices, such as the xylophone and vibraphone. However, the said device may also be used, apparently, to play multiple percussion instruments. The main disadvantage of this device is the need for additional equipment for disassembling and assembling the device. Furthermore, it is not clear from the description how it is possible to attach more than two percussion instruments in said device. This can also be considered a flaw.

### SUMMARY OF THE INVENTION

The task of the proposed invention is to design a percussion device which the users will be able to play with one hand while using several percussion instruments and increase the strength and durability of the device.

The proposed solution allows combining two or more percussive instruments into a single device, while using one hand when playing the percussion device.

The task at hand is solved in that the percussion device comprises at least two percussion instruments and the mounting unit. The percussion instrument has a stem and percussion surface which interacts with another percussion instrument and/or percussion surface. The mounting point is made of elastic material and has a hole for mounting the stems of the percussion instruments, wherein the maximum angle between the axes of the holes does not exceed 45°.

In this particular case, spoons are used as percussion instruments.

In this particular case, spoons are made of wood.

In this particular case, spoons are made of a polymeric material.

In this particular case, the bowl of at least one spoon is additionally equipped with a jingle.

In this particular case, the mounting unit is U-shaped, which also can be done while using spoons.

In this particular case, the mounting holes for mounting the stems of the percussion instruments are made in protruding parts of the U-shaped mounting unit.

In this particular case, protruding parts of the U-shaped mounting unit have different thicknesses.

### BRIEF DESCRIPTION OF THE DRAWINGS

The invention is further illustrated by the detailed description of specific, but not limiting the present solution, examples of its implementation and by accompanying drawings. Such description makes reference to the annexed drawings wherein:

FIG. 1—shows an embodiment of a percussion device;

FIG. 2—shows a U-shaped embodiment of the percussion device with spoons as percussion instruments;

FIG. 3—shows a U-shaped embodiment of the percussion device with walls of different thickness.

### DETAILED DESCRIPTION OF THE INVENTION

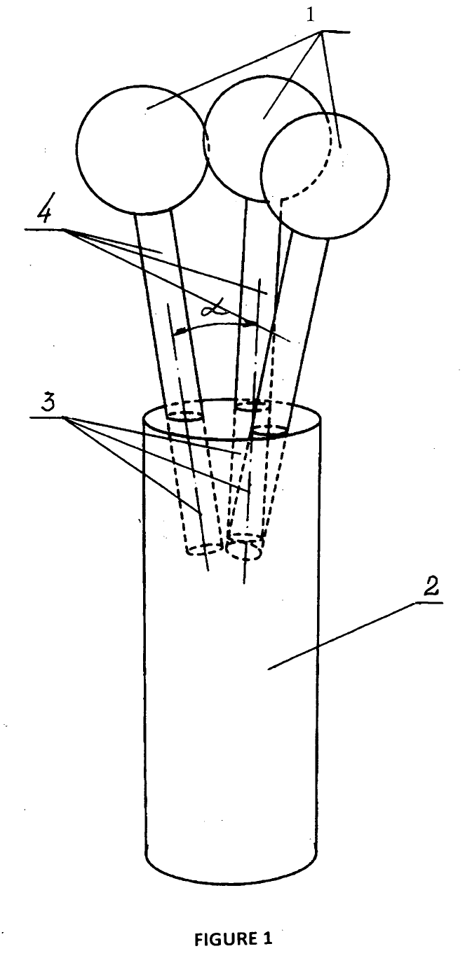

A percussion device shown in FIG. 1 consists of three percussion elements. In this example, maracas are used as percussion elements 1. There are holes 3 made in the mounting unit 2 which is made of elastic material, for example, rubber. The holes are arranged at an angle α to each other. Stems 4 of the percussion elements 1 are positioned in holes 3 of the mounting unit 2. In the aforementioned example, the percussion instrument is played by “shaking,” in a usual manner, but it is also possible to hit the percussion elements 1 against each other to add supplementary features to the percussion device.

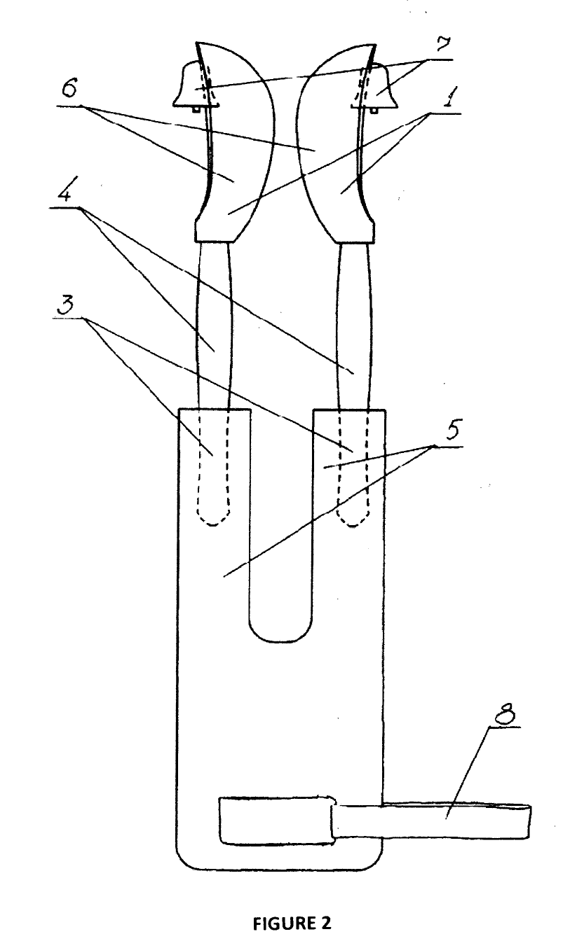

Another example of a percussion device is depicted in FIG. 2. Spoons are used as the percussion element 1. In this case, the percussion device is U-shaped. The mounting unit 2 is made of plastic polymeric material, for example. Holes 3 are made in the protruding parts 5 of the U-shaped percussion device. The stems 4 of the spoons are mounted in the holes 3 so that the concave sides 6 of the spoons are facing out.

In the example referenced above, when the pair is struck, the convex sides 6 of the spoons sharply hit each other. The spoons are typically struck against any object, player's body parts, or free hand.

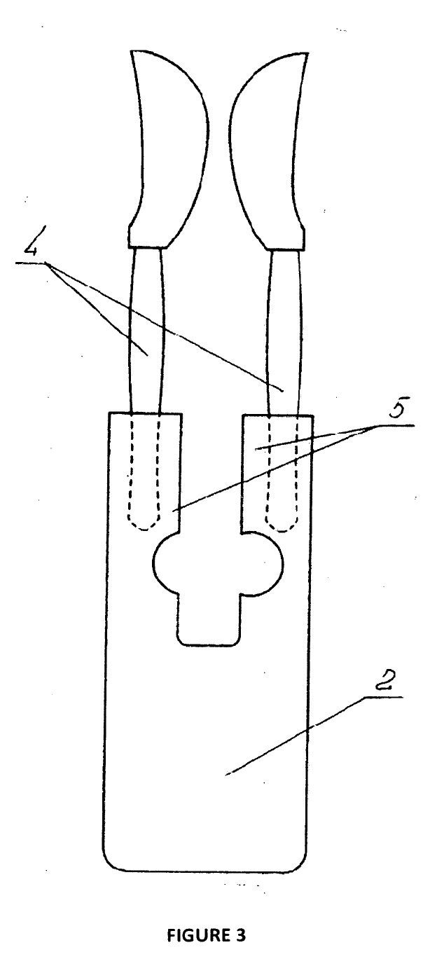

Another embodiment of the percussion device is shown in FIG. 3. In this case, the percussion device is also U-shaped, but the protruding parts 5 of the U-shaped percussion device are made with different thicknesses. Such a design makes the elasticity of the protruding parts 5 varying, so that the way of playing the percussion device can also be varying. There is an opportunity to hit the percussion elements 1, for example, spoons, by “shaking” a percussion device. Another option to make elasticity of the protruding parts 5 vary is to make the protruding parts 5 of different materials, for example, or to position additional stiffeners, such as a metal rod, in the protruding elements 5.

The spoons can be made of wood, for example, or to make the production cheaper, of polymer material.

If spoons are used as percussion element, it is possible to broaden the sound possibilities of the percussion device by adding a jingle 7 to the bowl 6 of the spoon, as shown in FIG. 2.

When carrying the assembled percussion device, it is convenient to use a strap 8, as shown in FIG. 2.

To broaden the range of sounds when using a percussion device, a set of different types and dimensions of the percussion elements 1 may be used, as well as various materials to make the percussion elements 1.

The claimed device can be manufactured using standard equipment, such as equipment for molding polymeric material.

### APPLICATION

The claimed device can be used both as a rhythmic instrument and as the background sound effects for sporting events, such as soccer or hockey competitions.

1. A percussion device comprising;
at least two percussion instruments and a mounting unit, whereby at least one percussion instrument has a stem and a percussion surface which interacts with another percussion instrument and/or percussion surface, and
the mounting unit is made of elastic material and has a hole for mounting the stems of the percussion instruments, wherein the maximum angle between the axis of the holes does not exceed 45°.

2. The percussion device as set forth in claim 1, including spoons used as the percussion instruments.

3. The percussion device as set forth in claim 2, wherein the spoons are made of wood.

4. The percussion device as set forth in claim 2, wherein the spoons are made of a polymeric material.

5. The percussion device as set forth in claim 2, wherein the bowl of at least one spoon is additionally equipped with a jingle.

6. The percussion device as set forth in claim 1, wherein the mounting unit is U-shaped.

7. The percussion device as set forth in claim 6, wherein the mounting holes for mounting the stems of the percussion instruments are made in protruding parts of the U-shaped mounting unit.

8. The percussion device as set forth in claim 6, wherein the protruding parts of the U-shaped mounting unit have different thicknesses.
